(19) United States
(12) Patent Application Publication
(10) Pub. No.: US 2006/0197423 A1
(43) Pub. Date: Sep. 7, 2006

(54) Reflector for light source of projector

(76) Inventors: Kunitoshi Mutsuki, Osaka (JP); Yohei Shimizu, Hyogo (JP)

Correspondence Address: JORDAN AND HAMBURG LLP, 122 EAST 42ND STREET, SUITE 4000, NEW YORK, NY, 10168, US

(21) Appl. No.: 11/367,131

(22) Filed: Mar. 3, 2006

(30) Foreign Application Priority Data
Mar. 4, 2005 (JP) 2005-61626

(51) Int. Cl. H01K 1/26; H01K 1/30; H01J 61/40; H01J 5/16

(52) U.S. Cl. 313/113

(57) ABSTRACT

A reflector for light source of a projector, comprises a cup-shaped part that is formed by forging or casting from aluminum metal or alloy or the like metal, inner face of the cup-shaped part being mirror finished by ultra-precise cutting technique or by grinding with buff or diamond powder as not to have grooves or distortion; and a barrel portion disposed at center of the cup-shaped part and configured to receive an electric-discharge lamp. Omitted thereby is a coating of silicone-based resin that is a must for a reflector formed by metal spinning technique as to cover up the grooves and distortion. Thus, good heat conductivity of the aluminum metal or the like is not hampered, as to achieve a reflector for high-luminance lamp with high power consumption.

### TECHNICAL FIELD

This invention relates to a reflector for an electric-discharge lamp that is used as a light source for a projector formed of a liquid-crystal display (LCD) or a digital light processing (DLP) device or the like.

### BACKGROUND ART

The projectors widely used before are formed of cathode-ray tubes and thus are bulky and weighty. Recently, however, the projectors formed of the LCD or DLP devices having smaller dimensions and weight have become widespread. The projector has a lens for enlarging and projecting an image formed on the LCD device for example, as to achieve a displaying on a large screen. Such projector has an electric-discharge lamp (tube or bulb) of high luminescence as to facilitate excellent visibility even in a bright room. When to increase brightness of the screen, electric power on the lamp has to be increased; and thus, heat generation is increased as to thereby cause trouble at reflective film disposed on inner side of the reflector as well as the electric-discharge lamp that is attached to the lamp reflector. Thus, optimization of construction of the reflector and heat-generation property of the lamp are required.

The reflector for the electric-discharge lamp is cup-shaped and has a barrel portion at bottom of such cup shape as to receive a base of the electric-discharge lamp in a manner that the base run through the barrel portion. The reflector used before has the reflective film disposed on inner face of a quartz glass part. Such reflector formed of glass has to be shaped in a mold, to which melted glass has been poured in. Thus, shape and dimensions of the reflector are apt to be deviated; and dielectric multi-layer film having several tens of layers is required as to increase reflection efficiency. Moreover, tolerable temperature of the lamp reflector is about 1200° C. while temperature around the lamp may become as high as 1000° C. Thus, the cooling by a fan is a must when to cope with such high temperature accompanied with increasing of the luminescence; and it is a biggest problem how to lead out, by conduction, heat at inner-center space of the reflector, at which the lamp is located.

Glass has low heat conductivity, and thus glass part is hard to be cooled by fanning. Thus, generated heat would not be escaped from inside of the reflector and might cause problems such as rupture of the lamp bulb or tube, which will cause spattering of mercury, due to excessive rising of its temperature; as to hamper enhancing of the luminescence. A protector glass shield is disposed to cope with such possible spattering of the mercury and then causes further increase of the temperature inside of the reflector as to somewhat contradict with the intention.

In view of the above, JP-1996(H08)-273401A (Japan's patent application publication No. 1996-273401 or H08-273401) discloses a construction of a lamp reflector formed of metal having good heat conductivity. On an inner surface of the reflector shaped as a curvature of revolution such as paraboloid, a reflective film is formed by vapor deposition of titanium dioxides (—TiO₂—) or of silicone dioxides (—SiO₂—). The JP-1996-273401A does not elaborate further on detailed construction of the metal reflector and the reflective film.

Meanwhile, a conventional metal reflector for the projector lamp is formed by spinning of an aluminum metal work in a way to form the curved face; and the curved face is coated with a silicone-based resin as an undercoat and is then vapor-deposited with aluminum film after curing of the resin undercoat. Such construction of the reflector has drawbacks in that; after the spinning-wise working, a press forming or a coating of the silicone resin is needed to achieve a smooth face, as to complicate a manufacturing process; and nevertheless, improvement of heat conductivity is small.

The spinning-wise working is schematically indicated in FIG. 4, and means a following method. In conformity with a spinning mandrel 51, a flat metal disc 52 is shaped by pressing with a “spoon” or a roller 53 in a manner of plastic forming. The spinning-wise working requires only simple equipment. Nevertheless, it is difficult to obtain a smooth surface with high reflective efficiency because inner face is formed by curving with compression stress. Moreover, deep grooves are formed along circle lines, and dotted pattern is formed at finished surface due to portion-to-portion-wise distortion. Thus, light beams reflected from the reflector are not in same direction. Consequently, enough luminance is not achievable when the reflector directly obtained by the spinning-wise working is used as it is.

For practical use, the reflector has to be further subjected to press working as to roughly eliminate or alleviate the grooves and the distortion; then to coating with silicone-based resin and its curing as to cover up the groove and the distortions and smooth the inner face; and subsequently to deposition of aluminum or other metal. Thus, complicated process steps are required. Moreover, while luminance of the reflector thus obtained is in a reasonable level, the reflector has a layer of the silicone-based resin that covers up the distortion; hence, the heat emitted from the lamp does not directly conveyed to the aluminum metal substrate of the reflector. Resultantly, heat conductivity of the reflector is considerably diminished. In short, thus obtained reflector is improved in heat conductivity from a glass-based reflector and nevertheless, such improvement is rather small and does not reach a level enabling the reflector to be used for the electric-discharge lamp requiring high power.

In view of the above, it is aimed to provide a reflector, for an electric-discharge lamp as a light source of a projector, which fully exhibits excellent heat conductivity of the aluminum or the like metal; and which in same time facilitates a high luminance of the lamp with high power consumption by use of an optimum production technique providing high-precision shaping on curved surface.

### BRIEF SUMMARY OF THE INVENTION

The invention-wise reflector comprises: a cup-shaped part that is formed by forging or casting from aluminum metal or alloy or the like metal, inner face of the cup-shaped part being mirror finished; and a barrel portion disposed at center of the cup-shaped part and configured to receive an electric-discharge lamp. Omitted thereby is a coating of silicone-based resin that is a must for a reflector formed by metal spinning technique as to cover up the grooves and distortion. Thus, good heat conductivity of the aluminum metal or the like is not hampered, as to achieve a reflector for high-luminance lamp with high power consumption.

### BRIEF DESCRIPTION OF THE DRAWING

FIG. 1 is a vertical sectional view showing an embodiment of the reflector for light source of the projector;

FIG. 2 is a flowchart showing an example of process steps for producing the reflector of FIG. 1;

FIG. 3 is a graph showing heat-dissipation efficiency of the reflector of the FIG. 1, in comparison with a conventional reflector; and

FIG. 4 is an explanatory sectional view showing a conventional process of spinning for producing a lamp reflector.

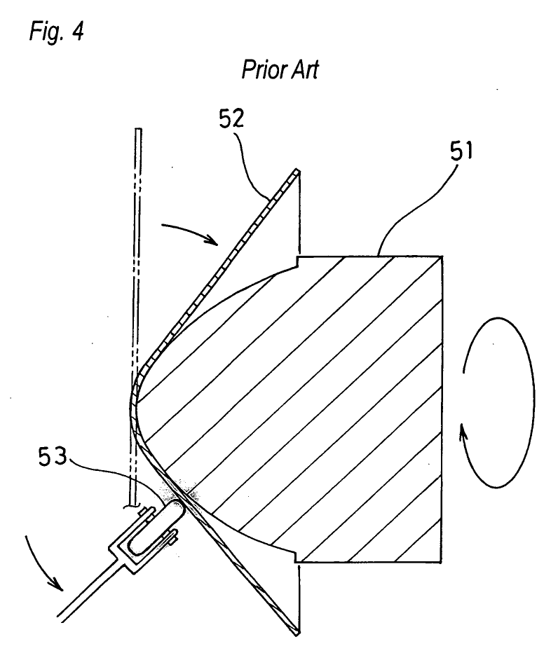

### DETAILED DESCRIPTION OF THE INVENTION

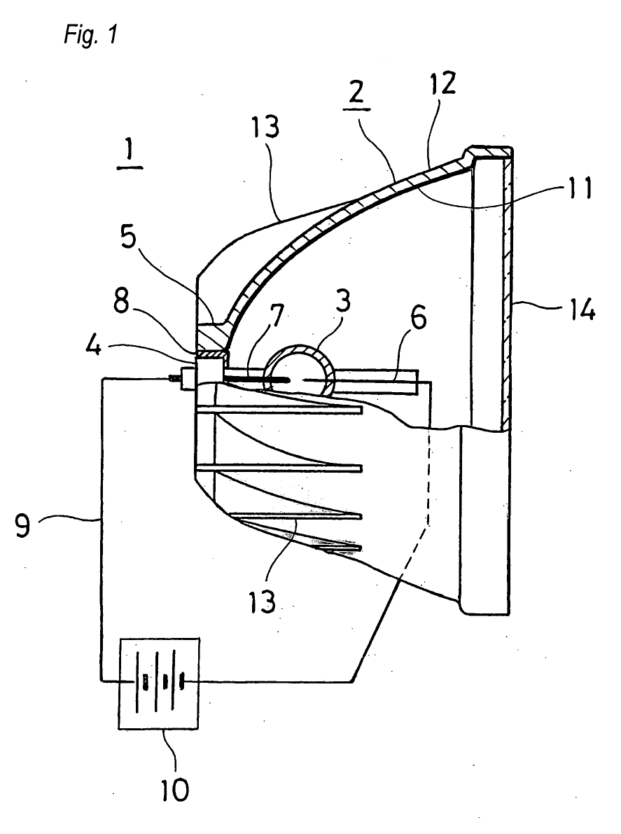

An embodiment of the invention-wise reflector for a light source of projector will be explained in conjunction with the drawings, for a case the reflector is used for a projector formed of an LCD device. FIG. 1 shows a projection light source 1 which is for the LCD projector and is formed of a cup-shaped reflector 2 and an electric-discharge lamp 3.

The reflector 2 is formed of a metal of good heat conductivity such as aluminum, and is shaped in a cup shape with thickness in a range of 2 through 3 mm by forging or casting. At a center of bottom of the cup shape, the reflector 2 has a barrel portion 5 that receives the base 4 of the electric-discharge lamp 3. In respect of forming method, the forging is preferred to the casting because the forged one has higher metallographic density and is easy to achieve surface finishing by cutting operation as to provide higher quality.

On ends of the lamp tube 3, cathode 6 and anode 7 is respectively formed as sealed off from the air. Each of the cathode 6 and the anode 7 is electrically connected with outer lead 9 through the lamp base 4 that is adhered on the barrel portion 5 of the reflector 2 by way of electrically insulative adhesive 8. A direct current (DC) power source 10 or an alternate current power source is connected through the outer leads 9 between the cathode 6 and the anode 7. Additionally, the reflector 2 has a protective glass pane 14 as a shield at front, which would curb spattering or escaping of mercury vapor if the electric-discharge lamp 3 were ruptured.

When a voltage from the power source 10 is applied, the electric-discharge lamp 3 is turned on, and light emitted from the lamp 3 is reflected on a cup-shaped inner face 11 of the reflector 2 as to send out a flood light. The flood light in white color is divided to light beams of three primary colors, and then sent into not-illustrated three LCD panels respectively dealing with the three primary colors, as to form monochrome images. Projections from the LCD panels are superimposed with each other as to form colored images, and then enlarged by a lens as to be projected on a screen.

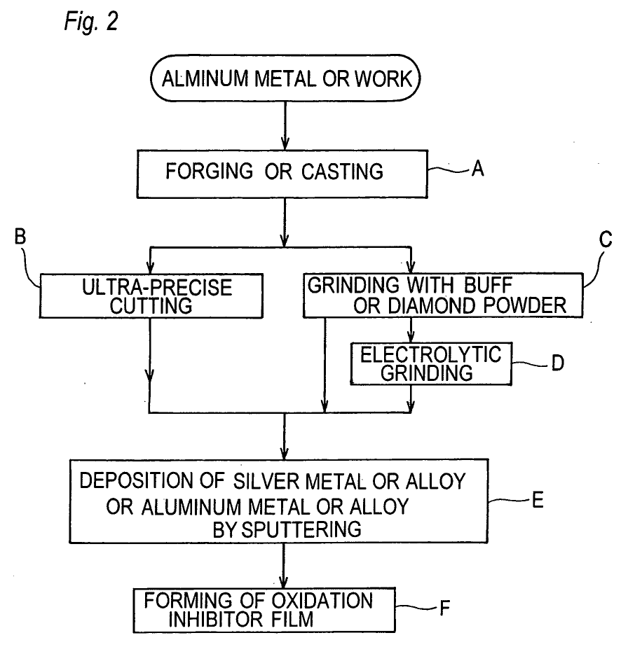

In following, an example of manufacturing process of the reflector 2 will be explained in accordance with a flow chart of FIG. 2. By the forging or casting at step A, the cup-shaped inner face 11 is finished in a manner as extremely precise in shaping and as smooth, and is yet to be mirror finished in a manner having high reflectance. Thus, the ultra-precise cutting (step B) is made on the cup-shaped inner face 11 as to form a mirror finished surface. The ultra-precise cutting is made by a diamond turning tool on an aluminum metal face in a precision at microns or at submicron. Therefore, foreign particles or substance such as abrasive are not inlayed on the surface and such mirror-finished surface is formed of the metal layer per se of the inner face 11. By the ultra-precise cutting, a smooth surface having no grooves or distortions is obtainable. Moreover, the ultra-precise cutting does not require coating on the to-be finished inner face with the silicone-based resin, which is must for the spinning-wise metal working. Thus, even when the inside of the reflector 2 is heated to high temperature by heat from the lamp 3, the heat is directly conveyed to metal part, formed of aluminum or other metal with good heat conductivity, of the reflector 2, without being hindered by a silicone resin layer. Thus, heat is efficiently dissipated to surrounding parts or to the air, through the metal layer or piece of the reflector.

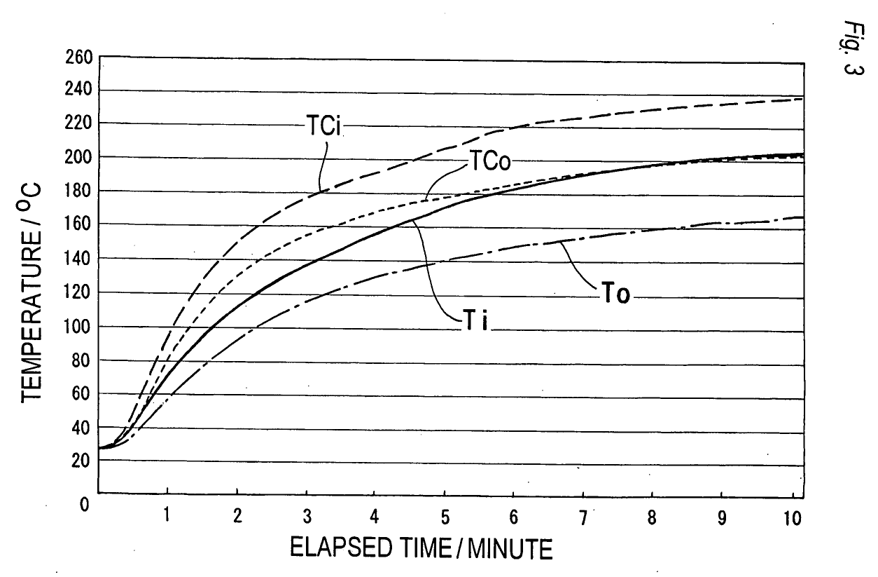

FIG. 3 is a graph showing heat-dissipation efficiency of thus forged reflector, in comparison with a conventional reflector. The graph shows experimental data on relationship between temperature on the reflector and a time elapsed after turning on of the electric-discharge lamp 3, which was lit for 10 minutes by a DC power source of 150 W. In the graph, “Ti” represents temperature at inner face of the forged reflector; and “To” represents temperature at outer face of the forged reflector. Meanwhile, “TCi” and “TCo” respectively represent temperatures at inner and outer faces of the conventional reflector. According to data on the graph for a timepoint at the 10 minute, the temperature Ti at inner face of the forged reflector was 206° C.; which is remarkably lower than corresponding temperature value of 237° C. that is temperature Tci at inner face of the conventional reflector. The forged reflector as it is was readily applicable for practical use.

During the spinning-wise metal working, thin plate is subjected to drawing as to produce a reflector at thickness in a range of 1.0 mm through 1.2 mm; and distribution of the aluminum metal becomes uneven so that mass center of the reflector deviates from center axis. Thus, the ultra-precision cutting or mechanical grinding is not applicable after the spinning-wise metal working. On contrary, forging-wise metal working facilitates; not only elimination of such problems, but also integral formation of fins 13 on outer face 12 of the reflector in a manner to facilitate more efficient dissipation of the heat. The fins 13 are formed around the barrel portion 5 receiving the lamp base 4, as linear walls projected in radial directions and in parallel with the axis, and is extended along outer face of the cup-shaped part toward its opening. As a result of forming the fins 13, heat-dissipating surface is remarkably enlarged as to increase the heat dissipation from the outer face and thereby decrease temperature of tube or bulb part of the lamp 3. Consequently, the power supplied to the lamp 3 may by increased as to achieve more luminous light source compared to one having a reflective smoothing layer on the reflector. Additionally, when air is blown to the reflector 2 having the fins 3 from rear side of the barrel portion 5 by a not-illustrated fan, the heat dissipation is further facilitated.

As a way for mirror finishing the inner face of the reflector 2 other than the ultra-precise cutting, there is adoptable a grinding with a buff or diamond powders as indicated as step C in FIG. 2. Such grinding is somewhat inferior in respect of mirror finished surface compared to the ultra-precise cutting. In order to increase precision of shaping and grinding, the inner face of the reflector may be subjected to an electrolytic grinding as indicated as step D in FIG. 2, after the grinding with buff or diamond powders, as to achieve excellent mirror face. The electrolytic grinding (step D) is also effective in curbing of oxidation on metal surface.

Although the reflector obtained by the above may be used as final product, smoothness and reflectivity on its surface is somewhat inferior to those on a mirror face formed on a glass sheet. When to cover up such drawback, the inner face 11 of the reflector 2 is further subjected to metal deposition or coating with silver metal or alloy or aluminum metal or alloy, preferably with aluminum-neodymium (AL—Nd) alloy or silver-neodymium (Ag—Nd) alloy, by sputtering technique as indicated as step E in the FIG. 2. The sputtering technique is a method of forming a metal thin coating layer adhered on the inner surface, by inducing sputtering out and deposition of metal atoms under vacuumed atmosphere. By such formation of metal thin film, fine undulation on the inner surface of the reflector is covered up as to increase its smoothness and reflectivity. Further, their fluctuation between the reflector products due to manufacturing process is reduced by the formation of metal thin film.

Other vapor deposition techniques are also adoptable, in which metal piece is heated to induce vaporization and then deposition under vacuum. The sputtering is preferable to a simple vapor deposition, because obtained film is homogeneous even when the film is thin and is highly adherent on a substrate and because the film formation is achievable within a short time even when forming a thick film.

Reflectivity of the aluminum metal surface is around 90%. In view of this, silver or silver alloy is deposited on the inner surface, by use of the sputtering technique or the like, when to achieve the reflectivity comparable or superior to that of the glass-based reflector. Due to a film of silver metal or alloy, reflectivity on the inner surface is increased by several percent as to increase luminance or to decrease power consumption.

The silver metal has reflectivity only next to that of gold. Nevertheless, adherence between the silver and aluminum metal layer is rather small. Thus, preferably, nickel metal or titanium metal film is deposited as an undercoat buffer layer, on the inner surface 11 formed of the aluminum metal. Meanwhile, the silver metal has rather low heat resistance, thus, surface of the silver film is easy to become undulated under heat from the lamp 3. To curb such undulation, palladium or neodymium is added to the silver metal or alloy by several percent.

The reflector 2 may be completed by such metal deposition as in above; nevertheless, such deposited metal film is rather easy to be oxidized when the lamp is used at its high luminance and thereby at high temperature. To curb such oxidation, the inner surface of the reflector 2 is further coated with an oxidation inhibitor film that is formed of silicone oxide, silicone nitride, silicone oxide-nitride, aluminum oxide, aluminum nitride or the like, as indicated as step F in the FIG. 2.

Each of the above process steps hereto explained may be modified, combined with the other, or omitted partly or entirely, in accordance with required or desired level of luminance of the light source or in view of its production cost.

### CROSS-REFERENCE TO RELATED APPLICATION

This application is based upon and claims the benefits of priority from the prior Japanese Patent Application No. 2005-061626 filed on Mar. 4, 2005; the contents of which is incorporated herein by reference.

What is claimed is

1. A reflector for light source of a projector, comprising: a cup-shaped part that is formed by forging or casting from aluminum metal or alloy or the like metal, inner face of the cup-shaped part being mirror finished; and a barrel portion disposed at center of the cup-shaped part and configured to receive an electric-discharge lamp.

2. A reflector according to claim 1, wherein heat-dissipating fins are arranged as projected from outer face of the barrel portion.

3. A reflector according to claim 1, wherein said inner face is subjected to ultra-precise cutting as a way for the mirror finishing, after the forging or casting.

4. A reflector according to claim 1, wherein, after the forging or casting, said inner face is subjected to mechanical grinding or subjected to the mechanical grinding and an electrolytic grinding as a way for the mirror finishing, and then is coated with silver metal or alloy or with aluminum metal or alloy.
